(19) United States
(12) Patent Application Publication
(10) Pub. No.: US 2019/0324889 A1
(43) Pub. Date: Oct. 24, 2019

(54) GENERATING FORMATTED MEMORY CONTENT IN A DEBUGGER

(71) Applicant: INTERNATIONAL BUSINESS MACHINES CORPORATION, Armonk, NY (US)

(72) Inventors: JIANG YI LIU, Beijing (CN); XIAO LING CHEN, Beijing (CN); YAN HUANG, Beijing (CN); WEI WU, Beijing (CN); CHUAN HE, Beijing (CN); LEI AB WANG, Beijing (CN); YONG QING XU, Beijing (CN); XUE YONG ZHANG, Beijing (CN)

(21) Appl. No.: 15/957,028

(22) Filed: Apr. 19, 2018

(51) Int. Cl. G06F 11/36; G06F 17/30

(52) U.S. Cl. CPC G06F 11/3636; G06F 17/30339; G06F 11/3664

(57) ABSTRACT

A computer-implemented method includes analyzing memory content a first time, where the memory content results from running a program. Based on the analyzing the memory content the first time, first description data is generated describing a plurality of instances of a plurality of known data structures defined in the program. A request is received for a plurality of instances of a new data structure, where the new data structure is not defined in the program. A definition of the new data structure is received separate from the program. Based on the analyzing the memory content a second time, second description data is generated describing a plurality of instances of the new data structure.

### BACKGROUND

The present invention relates to debugging and, more specifically, to generating formatted memory content in a debugger.

While debugging a program, a user may wish to view data stored in memory. For instance, viewing this data may enable a user to determine when values are unexpected or abnormal and may thus be negatively impacting a program. Viewing data in memory may be particularly useful when the program is written in assembler code or is not configured to output debug information. Some existing debuggers are able to display memory content directly, which can be useful for users desiring to perform manual debugging.

### SUMMARY

Embodiments of the present invention are directed to a computer-implemented method for generating formatted memory content in a debugger. A non-limiting example of the computer-implemented method includes analyzing memory content a first time, where the memory content results from running a program. Based on the analyzing the memory content the first time, first description data is generated describing a plurality of instances of a plurality of known data structures defined in the program. A request is received for a plurality of instances of a new data structure, where the new data structure is not defined in the program. A definition of the new data structure is received separate from the program. Based on the analyzing the memory content a second time, second description data is generated describing a plurality of instances of the new data structure.

Embodiments of the present invention are directed to a system for generating formatted memory content in a debugger. A non-limiting example of the system includes a memory having computer-readable instructions and one or more processors for executing the computer-readable instructions. The computer-readable instructions include analyzing memory content a first time, where the memory content results from running a program. Based on the analyzing the memory content the first time, first description data is generated describing a plurality of instances of a plurality of known data structures defined in the program. A request is received for a plurality of instances of a new data structure, where the new data structure is not defined in the program. A definition of the new data structure is received separate from the program. Based on the analyzing the memory content a second time, second description data is generated describing a plurality of instances of the new data structure.

Embodiments of the invention are directed to a computer-program product for generating formatted memory content in a debugger, the computer-program product comprising a computer-readable storage medium having program instructions embodied therewith. The program instructions are executable by a processor to cause the processor to perform a method. A non-limiting example of the method includes analyzing memory content a first time, where the memory content results from running a program. Based on the analyzing the memory content the first time, first description data is generated describing a plurality of instances of a plurality of known data structures defined in the program. A request is received for a plurality of instances of a new data structure, where the new data structure is not defined in the program. A definition of the new data structure is received separate from the program. Based on the analyzing the memory content a second time, second description data is generated describing a plurality of instances of the new data structure.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a diagram of a debugging system according to some embodiments of this invention;

FIG. 2 is a flow diagram of a method for debugging a program, according to some embodiments of this invention;

FIG. 3 illustrates example description data that results from analyzing memory content, according to some embodiments of this invention;

FIG. 4 is an example table showing description data associated with a data structure, according to some embodiments of this invention; and

FIG. 5 is a block diagram of a computer system for implementing some or all aspects of the debugging system, according to some embodiments of this invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two- or three-digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, the memory content displayed in existing debuggers is provided without structure and, as a result, is likely to be incomprehensible or at least lacking usefulness to a high degree. For instance, the memory content may be displayed in hexadecimal format or character format. To utilize this information, users must manually map the displayed memory content to specific data structures used in the program being debugged. This mapping can be both time- and energy-intensive. Only after this mapping is performed does it become clear what the memory content means.

Turning now to an overview of the aspects of the invention, one or more embodiments of the invention address the above-described shortcomings of the prior art by providing a mechanism for generating more useful data in the output of a debugger. Specifically, according to some embodiments of the invention, a debugging system identifies data structures, or types, defined in a program and also accepts user-defined data structures at an interface of the debugger. When displaying memory content, the debugging system may generate data in a customized format based on these data structures, including those that are not defined in the program itself.

The above-described aspects of the invention address the shortcomings of the prior art by improving the scope of conventional debuggers. Specifically, according to some embodiments of the invention, a debugging system enables users to view memory content in a format that a user prefers, regardless of whether that format is loaded through the program or defined after the fact. The result is an improved debugger that can be used to locate problems that might not have been found otherwise. Such problems are identified quickly and conveniently, even when the program is large and complicated.

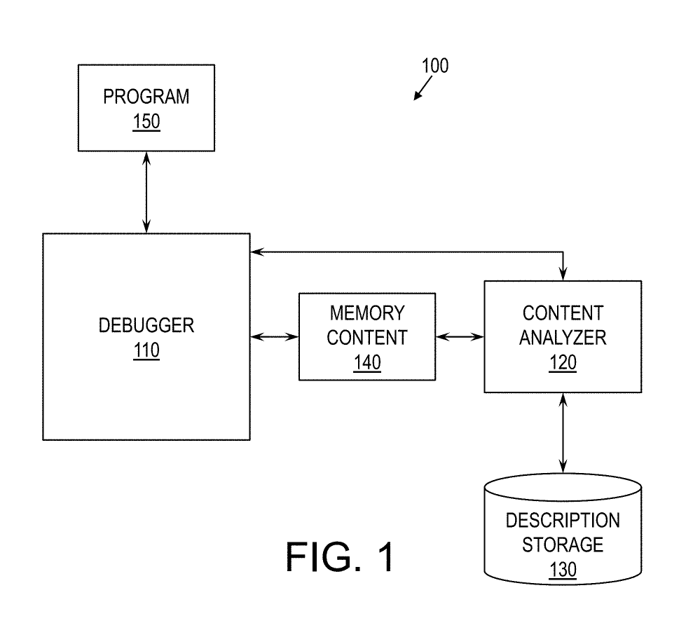

Turning now to a more detailed description of aspects of the present invention, FIG. 1 is a block diagram of a debugging system 100 according to some embodiments of this invention. As shown in FIG. 1, the debugging system 100 may include a debugger 110, which may be in communication with a content analyzer 120 and a description storage 130. In some embodiments, the content analyzer 120 and the description storage 130 are distinct from the debugger 110. Alternatively, however, one or more of these components, in whole or part, may be integrated with the debugger 110. The debugger 110, the content analyzer 120, and the description storage 130 may each include hardware, software, or a combination of both. For example, and not by way of limitation, each of these may be implemented as a hardware circuit.

Generally, a program 150 to be debugged may run to a break point or an error within the program 150, which may result in memory content 140 being written. In some embodiments of the invention, the program 150 may run inside the debugger 110, but alternatively, the program 150 may be run separately from the debugger 110. In some embodiments of the invention, particularly when the program 150 is run separately from the debugger 110, the debugger 110 may have access to one or more source files, modules, or object files or the program 150, thus enabling the content analyzer 120 access to known data structures defined in the program 150. The content analyzer 120 may use this access to identify instances of the known data structures in the memory content 140, and to store descriptions of those instances in the description storage 130, as will be described further below.

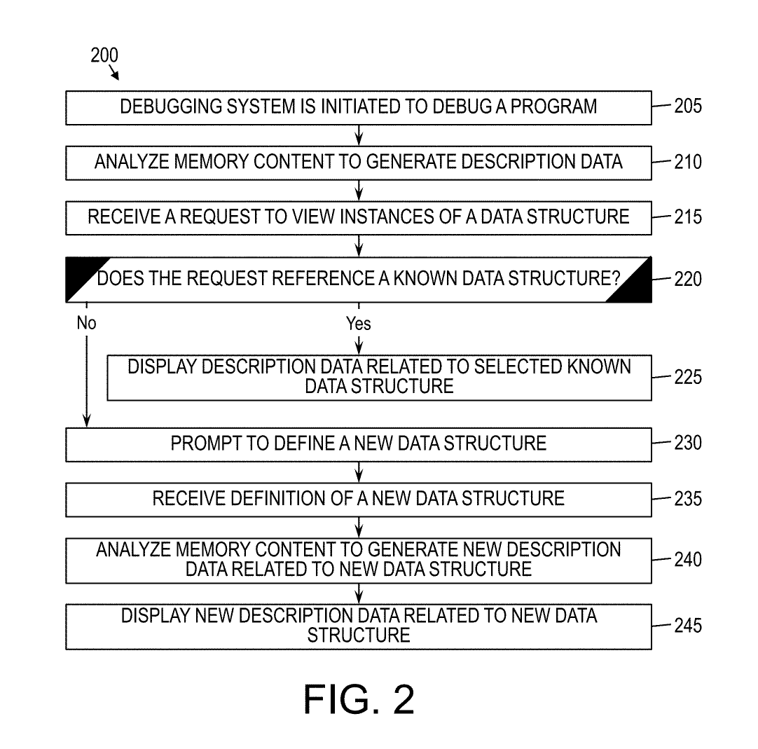

FIG. 2 is a flow diagram of a method 200 for debugging a program 150, according to some embodiments of this invention. As shown in FIG. 2, at block 205, the debugging system 100 may be initiated to debug the program 150. The debugging may be initiated through various mechanisms. For example, and not by way of limitation, the program 150 may throw an error or reach a break point while running, and the event of that error or break point may initiate debugging of the program 150. For another example, a user may manually start the debugging system 100 to debug the program 150. Regardless of how the debugging system 100 is initiated, it may have access to debug data related to the program 150. This debug data may include, for example, source files, compiler output related to the program 150, object files resulting from compiling the program, memory content 140 resulting from running the program 150, or other information. Memory content 140 may exist as a result of running the program 150, where the memory content 140 is data generated by the program 150 in memory. Generally, the memory content 140 is in a format that is not easily human-readable.

At block 210, the content analyzer 120 may analyze, or parse, the memory content 140, thereby generating description data to be stored in the description storage 130. In analyzing the memory content 140, the content analyzer 120 may extract the description data from the memory content 140. The description data may include a record for each instance of each known data structure, where known data structures are data structures that are defined in the program 150 and thus known to the content analyzer 120. By analyzing the memory content 140, the content analyzer 120 may identify instances of the known data structures and determine information about those instances. The specific mechanism of analyzing the memory content may be dependent, at least in part on how the memory content was written, which may depend on various factors, such as the computer architecture on which the program 150 was run. Generally, however, the analysis may include parsing the memory content according to a known format of the memory content 140. One of skill in the art will understand how to build such a parser based on how the memory content 140 is generated and formatted.

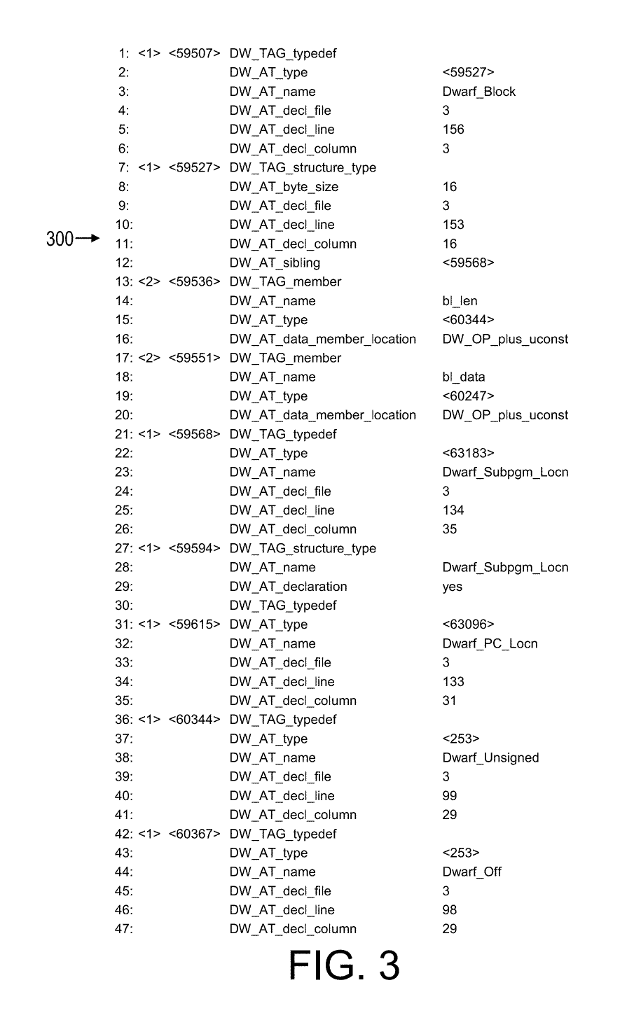

FIG. 3 illustrates example description data 300 resulting from analyzing the memory content 140, according to some embodiments of the invention. It will be understood that various formats may be used for the description data 300 and that the example shown is for illustrative purposes only. In this example, the description data is in a format that may be stored within a single file, and thus the description storage 130 may be a file. Alternatively, for example, the description storage 130 may be a table in a database. In the example of FIG. 3, various levels of content are indicated by angle brackets, where “<1>” refers to a first level and “<2>” refers to a second level. In this disclosure, a level associated with a higher number (e.g., a second level versus a first level) will be referred to as a higher level. It will be understood that, while only two levels are shown in this example, additional levels may also be included in the description data 300.

In this example, each first level of data describes an instance of a data structure, or type, while a second level or higher level underneath that first level describes a variable within the instance. Each such variable may be a standard type (e.g., an integer, a string) or a data structure itself. If a particular variable is itself an instance of a data structure, another first level of data describes the instance of that particular variable in more detail.

In the example description data 300 of FIG. 3, known data structures include Dwarf_Block and bl_len, which each have instance numbers appearing at a first level. In this example, the indicator string “DW_AT_type” identifies an instance identifier of a data structure; “DW_AT_name” identifies a name of a data structure; and “DW_AT_byte_size” identifies a size of a data structure. Thus, based on lines 2-3 of the description data 300, instance 59527 is an instance of the Dwarf_Block type. In some embodiments of the invention, the instance identifiers may be, or may be based on, addresses in the memory content 140. Thus, the instance identifier of an instance of a data structure may describe the location of that data structure in the memory content 140. Because the instance identifier, 59527, appears at a first level, at line 7, the information between line 7 and the next first level relates to this particular instance of the Dwarf_Block type. Specifically, as indicated at line 8, the instance has a size of 16 bytes, and as indicated by the introduction of second levels at lines 13 and 17, bl_len and bl_data are variables within this instance 59527. One of skill in the art will understand how to utilize this description data 300 as described further below. For example, and not by way of limitation, the description data may be parsed recursively, treating the levels as a tree structure, to extract information about a specific instance.

At block 215, the debugging system 100 may receive a request to view instances of a data structure. This request may be received in various manners. For example, and not by way of limitation, the debugging system 100 may provide a graphical user interface with a drop-down box. The drop-down box may list the known data structures, enabling the user to select a data structure from among the known data structures. The debugging system 100 may interpret the selection of a data structure as a request to view instances of the data structure.

At decision block 220, it may be determined whether the request references a known data structure. According to some embodiments of the invention, a user can request to view instances of a known data structure, or the user can define a new data structure for which instances are desired to be viewed. For example, and not by way of limitation, if a drop-down box is used as described above, the drop-down box may include a list of known data structures as well as a list option to input a new data structure. In that case, if a selection is made to input a new data structure, then the debugging system 100 may interpret the selection as a desire to add a new data structure to the set of known data structures.

If the request refers to a known data structure, now referred to herein as the selected data structure, then at block 225, the debugging system 100 may display the description data 300 related to the selected data structure. Specifically, in some embodiments of the invention, the debugging system 100 displays each instance of the selected data structure in the description data 300, which may represent each instance of the selected data structure in the memory content 140. Further, in some embodiments of the invention, the description data 300 related to the selected data structure is displayed in a table format for convenient use and understanding by a human user. Each row, or record, of the table may correspond to an instance of the selected data structure, and each field may correspond to a variable of that instance. Each row may include at least one identifier, such as the instance identifier or an address in the memory content 140 at which the instance was last assigned a value. Within a row, each field may include a value corresponding to the respective variable of the respective instance. If the variable is itself a data structure, then in some embodiments, the value included may be an address in the memory content at which that variable was found.

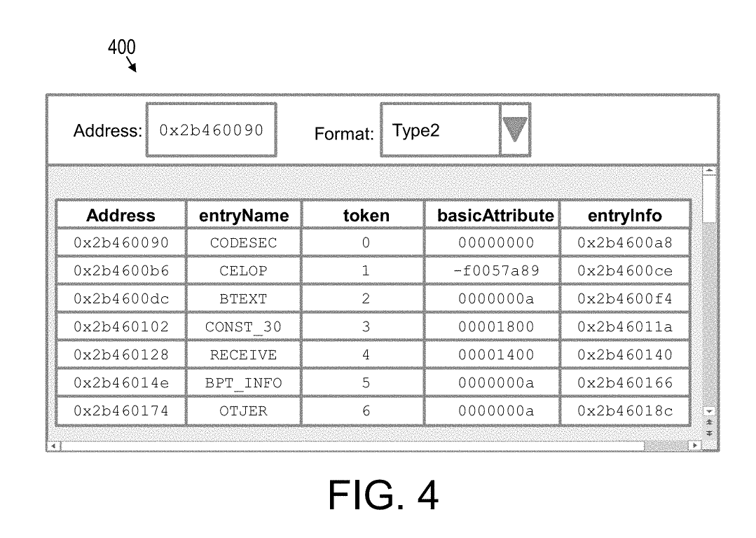

FIG. 4 is an example table showing a table 400 of the description data 300 related to a data structure named Type2. In this example, seven instances of the Type2 data structure are displayed, with each instance corresponding to a row of the table 400. In this example, the Address field of the table 400 may be a location of the instance corresponding to the respective row. The variables of the Type2 data structure, which are entryName, token, basicAttribute, and entryInfo, are displayed in the fields of the table 400. Because entryInfo is a data structure, however, the value displayed in that field of each row is a pointer, which provides the address of the instance of the entryInfo data structure.

In some embodiments of this invention, values of variables in the table 400 are editable. As such, the user may modify these values. Upon receipt of a modification, the debugging system may modify the memory content 140 to match the modification may be the user. In some embodiments of the invention, the debugging system 100 may then continue running the program 150 at the break point or error event. As a result, it may be determined whether the modification solves whatever issue the user is experiencing with the program 150.

Further, in some embodiments of the invention, the debugging system 100 also enables the user to input an address of a desired instance. Upon receiving that address, the debugging system 100 may compare the address to the description data 300, specifically to the instance identifiers, for example, and thereby identify which instance occurs at that address. The debugging system may then display the description data related to that instance or related to the known data structure to which that instance belongs.

If, at decision block 220, the request references a data structure that is not yet known, then at block 230, the debugging system 100 may prompt the user to define a new data structure. The new data structure need not be completely undefined before this point. Rather, for example, the new data structure may already be defined in a source file of a second program, where the second program is other than the program 150 being debugged, and where the debugging system 100 does not have access to the second program. Introduction of the new data structure may be useful because the program 150 may utilize data structures that are not defined in the program 150 itself, such as in the source files, modules, or object files of the program 150. For example, and not by way of limitation, a new data structure may be defined in a separate module that is inaccessible to the debugging system 100 although used by the program 150.

The debugging system 100 may use various mechanisms to enable the user to define a new data structure. For example, and not by way of limitation, the debugging system 100 may present a text field, in which the user may enter code that defines the new data structure. For another example, the debugging system 100 may provide the user with an editable table that includes text fields, where each row, or record, represents a variable of the new data structure. On each row, the user may enter a new variable name, size, and type, for example. The user may also be enabled to enter a name, size, or other information about the new data structure.

Thus, at block 235, the debugging system 100 may receive a definition of the new data structure from the user. At block 240, the content analyzer 120 may analyze the memory content 140 to generate new description data related to the new data structure, and this new description data may be added to the description storage 130. The debugging system 100 may then add the new data structure to the set of known data structures. If a drop-down box is used for selection, the new data structure may appear in the drop-down box in the future. In some embodiments of the invention, however, receipt of the new data structure may automatically be interpreted as a selection of the new data structure. As such, at block 245, the debugging system 100 may display the new description data 300 related to the new data structure. As discussed above, this display may take the form of a table 400. Further, as discussed above, the user may modify values in the table to result in modifications to the memory content 140.

In some embodiments of the invention, blocks 215 to 245 are repeated each time a request to view instances of a data structure is received based on current memory content 140.

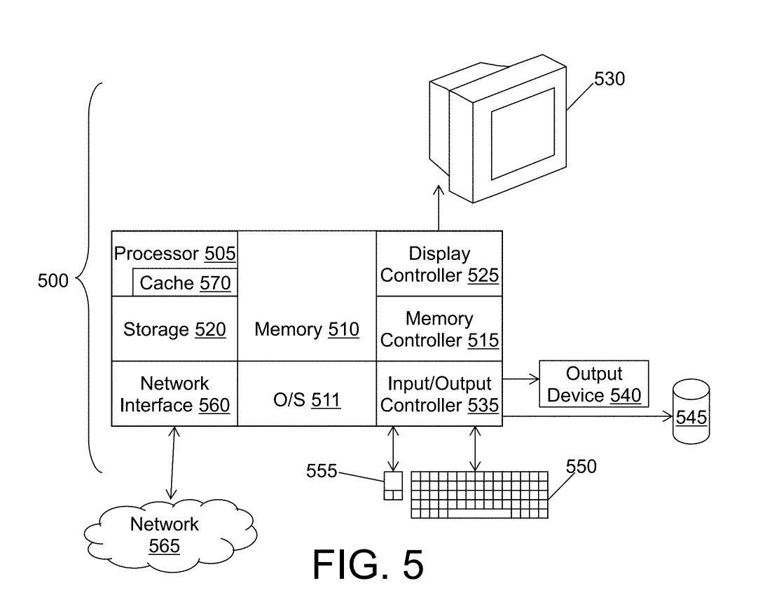

FIG. 5 is a block diagram of a computer system 500 for implementing some or all aspects of the system, according to some embodiments of this invention. The debugging systems 100 and methods described herein may be implemented in hardware, software (e.g., firmware), or a combination thereof. In some embodiments, the methods described may be implemented, at least in part, in hardware and may be part of the microprocessor of a special or general-purpose computer system 500, such as a personal computer, workstation, minicomputer, or mainframe computer.

In some embodiments, as shown in FIG. 5, the computer system 500 includes a processor 505, memory 510 coupled to a memory controller 515, and one or more input devices 545 and/or output devices 540, such as peripherals, that are communicatively coupled via a local I/O controller 535. These devices 540 and 545 may include, for example, a printer, a scanner, a microphone, and the like. Input devices such as a conventional keyboard 550 and mouse 555 may be coupled to the I/O controller 535. The I/O controller 535 may be, for example, one or more buses or other wired or wireless connections, as are known in the art. The I/O controller 535 may have additional elements, which are omitted for simplicity, such as controllers, buffers (caches), drivers, repeaters, and receivers, to enable communications.

The I/O devices 540, 545 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 505 is a hardware device for executing hardware instructions or software, particularly those stored in memory 510. The processor 505 may be a custom made or commercially available processor, a central processing unit (CPU), an auxiliary processor among several processors associated with the computer system 500, a semiconductor-based microprocessor (in the form of a microchip or chip set), a macroprocessor, or other device for executing instructions. The processor 505 includes a cache 570, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 570 may be organized as a hierarchy of more cache levels (L1, L2, etc.).

The memory 510 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 510 may incorporate electronic, magnetic, optical, or other types of storage media. Note that the memory 510 may have a distributed architecture, where various components are situated remote from one another but may be accessed by the processor 505.

The instructions in memory 510 may include one or more separate programs, each of which comprises an ordered listing of executable instructions for implementing logical functions. In the example of FIG. 5, the instructions in the memory 510 include a suitable operating system (OS) 511. The operating system 511 essentially may control the execution of other computer programs and provides scheduling, input-output control, file and data management, memory management, and communication control and related services.

Additional data, including, for example, instructions for the processor 505 or other retrievable information, may be stored in storage 520, which may be a storage device such as a hard disk drive or solid-state drive. The stored instructions in memory 510 or in storage 520 may include those enabling the processor to execute one or more aspects of the debugging systems 100 and methods of this disclosure.

The computer system 500 may further include a display controller 525 coupled to a display 530. In some embodiments, the computer system 500 may further include a network interface 560 for coupling to a network 565. The network 565 may be an IP-based network for communication between the computer system 500 and an external server, client and the like via a broadband connection. The network 565 transmits and receives data between the computer system 500 and external systems. In some embodiments, the network 565 may be a managed IP network administered by a service provider. The network 565 may be implemented in a wireless fashion, e.g., using wireless protocols and technologies, such as WiFi, WiMax, etc. The network 565 may also be a packet-switched network such as a local area network, wide area network, metropolitan area network, the Internet, or other similar type of network environment. The network 565 may be a fixed wireless network, a wireless local area network (LAN), a wireless wide area network (WAN) a personal area network (PAN), a virtual private network (VPN), intranet or other suitable network system and may include equipment for receiving and transmitting signals.

Debugging systems 100 and methods according to this disclosure may be embodied, in whole or in part, in computer program products or in computer systems 500, such as that illustrated in FIG. 5.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
reading memory content from a memory of a debugging system, wherein the memory content is written to the memory as a result of running a program in need of debugging;
analyzing the memory content a first time;
generating first description data describing a plurality of instances of a plurality of known data structures defined in the program in need of debugging, based on analyzing the memory content the first time;
receiving a request for a plurality of instances of a new data structure, wherein the new data structure is not defined in the program in need of debugging, wherein the new data structure is defined in a program inaccessible to the program in need of debugging;
receiving a definition of the new data structure separate from the program in need of debugging;
analyzing the memory content a second time, responsive to receiving the definition of the new data structure; and
generating second description data describing a plurality of instances of the new data structure, based on analyzing the memory content the second time.

2. The computer-implemented method of claim 1, further comprising:
receiving a request for a plurality of instances of a first data structure of the plurality of known data structures;
parsing the first description data to identify each instance of the first data structure; and
displaying in a table each instance of the first data structure.

3. The computer-implemented method of claim 2, wherein displaying in the table each instance of the first data structure comprises:
assigning each instance of the first data structure to a respective record of the table; and
assigning a first variable of the first data structure to a first field of the table;
wherein the first variable is an instance of a second data structure, and wherein a value of the first variable is a pointer to an instance of the second data structure.

4. The computer-implemented method of claim 3, further comprising:
receiving a modification of an edited field of the table;
applying the modification to the memory content in the memory of the computer system; and
continuing to run the program in need of debugging on the computer system after applying the modification to the memory content.

5. The computer-implemented method of claim 1, wherein receiving the definition of the new data structure separate from the program in need of debugging comprises:
presenting a user with an editable table comprising a plurality of records, wherein each record corresponds to a variable of the new data structure;
receiving text entry in the editable table; and
interpreting the text entry as the new data structure.

6. The computer-implemented method of claim 1, further comprising:
parsing the second description data to identify each instance of the new data structure; and
displaying in a table each instance of the new data structure.

7. The computer-implemented method of claim 1, further comprising:
receiving an address in the memory content;
parsing the second description data to identify a first instance of the new data structure at the address; and
displaying a description of the first instance of the new data structure.

8. A system comprising:
a memory having computer-readable instructions; and
one or more processors for executing the computer-readable instructions, the computer-readable instructions comprising:
reading memory content from a memory of a debugging system, wherein the memory content is written to the memory as a result of running a program in need of debugging;
analyzing the memory content a first time;
generating first description data describing a plurality of instances of a plurality of known data structures defined in the program in need of debugging, based on analyzing the memory content the first time;
receiving a request for a plurality of instances of a new data structure, wherein the new data structure is not defined in the program in need of debugging, wherein the new data structure is defined in a program inaccessible to the program in need of debugging;
receiving a definition of the new data structure separate from the program in need of debugging;
analyzing the memory content a second time, responsive to receiving the definition of the new data structure; and
generating second description data describing a plurality of instances of the new data structure, based on analyzing the memory content the second time.

9. The system of claim 8, the computer-readable instructions further comprising:
receiving a request for a plurality of instances of a first data structure of the plurality of known data structures;
parsing the first description data to identify each instance of the first data structure; and
displaying in a table each instance of the first data structure.

10. The system of claim 9, wherein displaying in the table each instance of the first data structure comprises:
assigning each instance of the first data structure to a respective record of the table; and
assigning a first variable of the first data structure to a first field of the table;
wherein the first variable is an instance of a second data structure, and wherein a value of the first variable is a pointer to an instance of the second data structure.

11. The system of claim 10, the computer-readable instructions further comprising:
receiving a modification of an edited field of the table;
applying the modification to the memory content in the memory of the computer system; and
continuing to run the program in need of debugging on the computer system after applying the modification to the memory content.

12. The system of claim 8, wherein receiving the definition of the new data structure separate from the program in need of debugging comprises:
presenting a user with an editable table comprising a plurality of records, wherein each record corresponds to a variable of the new data structure;
receiving text entry in the editable table; and
interpreting the text entry as the new data structure.

13. The system of claim 8, the computer-readable instructions further comprising:
parsing the second description data to identify each instance of the new data structure; and
displaying in a table each instance of the new data structure.

14. (canceled)

15. A computer-program product comprising a computer-readable storage medium having program instructions embodied therewith, the program instructions executable by a processor to cause the processor to perform a method comprising:
reading memory content from a memory of a debugging system, wherein the memory content is stored to the memory as a result of running a program in need of debugging;
analyzing the memory content a first time;
generating first description data describing a plurality of instances of a plurality of known data structures defined in the program in need of debugging, based on analyzing the memory content the first time;
receiving a request for a plurality of instances of a new data structure, wherein the new data structure is not defined in the program in need of debugging, wherein the new data structure is defined in a program inaccessible to the program in need of debugging;
receiving a definition of the new data structure separate from the program in need of debugging;
analyzing the memory content a second time, responsive to receiving the definition of the new data structure; and
generating second description data describing a plurality of instances of the new data structure, based on analyzing the memory content the second time.

16. The computer-program product of claim 15, the method further comprising:
receiving a request for a plurality of instances of a first data structure of the plurality of known data structures;
parsing the first description data to identify each instance of the first data structure; and
displaying in a table each instance of the first data structure.

17. The computer-program product of claim 16, wherein displaying in the table each instance of the first data structure comprises:
assigning each instance of the first data structure to a respective record of the table; and
assigning a first variable of the first data structure to a first field of the table;
wherein the first variable is an instance of a second data structure, and wherein a value of the first variable is a pointer to an instance of the second data structure.

18. The computer-program product of claim 15, wherein receiving the definition of the new data structure separate from the program in need of debugging comprises:
presenting a user with an editable table comprising a plurality of records, wherein each record corresponds to a variable of the new data structure;
receiving text entry in the editable table; and
interpreting the text entry as the new data structure.

19. The computer-program product of claim 15, the method further comprising:
parsing the second description data to identify each instance of the new data structure; and
displaying in a table each instance of the new data structure.

20. The computer-program product of claim 15, the method further comprising:
receiving an address in the memory content;
parsing the second description data to identify a first instance of the new data structure at the address; and
displaying a description of the first instance of the new data structure.

21. The computer-implemented method of claim 1, further comprising:
executing the program in need of debugging on the computer system; and
writing the memory content to the memory of the computer system as the program in need of debugging executes.
